(19) United States
(12) Patent Application Publication
(10) Pub. No.: US 2003/0039805 A1
(43) Pub. Date: Feb. 27, 2003

(54) Removable retroreflective material

(75) Inventor: Mary A. Ericksen, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 09/934,031

(22) Filed: Aug. 20, 2001

(51) Int. Cl. B32B 1/00

(52) U.S. Cl. 428/144; 428/143; 428/149

(57) ABSTRACT

A disposable retroreflective tape is described that has a pressure-sensitive adhesive that can be comfortable adhered to human skin. The tape includes a foam or non-woven backing. Retroreflective beads are melted into a first side of the backing using a laminator. A second side of the backing is coated with the pressure-sensitive adhesive material. The retroreflective beads melted into the first side of the backing to provide the disposable tape with a retroreflective surface without the use of an additional adhesive or resin.

### FIELD

This disclosure relates to retroreflective material and, more particularly, beaded retroreflective material.

### BACKGROUND

Retroreflective materials have been used in a variety of applications, including road signs, license plates, footwear, and clothing patches to name a few. Retroreflectivity can be provided in a variety of ways, including by use of a layer of tiny glass beads or microspheres that cooperate with a reflective agent such as a coated layer of aluminum. The beads are typically embedded in a binder layer that holds the beads to fabric such that the beads are partially exposed to the atmosphere. Each bead focuses incident light entering the exposed portion of a bead onto the reflective agent, which is typically disposed at the back of the bead embedded in the binder layer. The reflective agent reflects the incident light back through the bead, causing the light to exit through the exposed portion of the bead in a direction opposite the incident direction.

Conventionally, beaded retroreflective materials may be formed using a number of techniques. According to one process, a monolayer of aluminum-coated glass beads is deposited on a curable resin. Curing the resin fixes the glass beads on the surface of the resin. The glass beads may be coated with aluminum on half of the surface area of the beads, in which case the beads must be deposited such that the aluminum coated area is set in the resin. This can be done, for example, by depositing uncoated beads on a substrate, coating the exposed surface of the beads with aluminum, pressing the substrate into a curable resin, curing the resin, and then peeling back the substrate. Alternatively, the glass beads may be fully coated with aluminum, in which case the aluminum on the exposed area of the glass beads is etched away after the beads have been fixed in the curable resin. In other conventional applications, half coated aluminum beads are mixed into a resin in random orientations. The resin can then be applied to the desired surface before being cured.

### SUMMARY

This disclosure is directed toward disposable retroreflective material that can be comfortably adhered to human skin, and easily discarded after use. In particular, the material makes use of a pressure-sensitive adhesive to provide a surface that can be adhered to skin or clothing, and also makes use of retroreflective beads to provide a retroreflective surface on the disposable material. The material may include a foam or non-woven backing. Retroreflective beads are melted into a first side of the backing using a laminator, or the like, to provide the material with the retroreflective surface. A second side of the backing is coated with the pressure-sensitive adhesive.

In one aspect, this disclosure provides a pressure-sensitive adhesive tape including an adhesive side and a non-adhesive side, and a layer of retroreflective beads melted into the non-adhesive side of the pressure-sensitive adhesive tape. The pressure-sensitive adhesive may be medical grade adhesive capable of being comfortably adhered to human skin, yet easily removed. The retroreflective beads can be melted into the non-adhesive side of the pressure-sensitive tape without the use of an additional adhesive material or resin. In one case, the backing of the tape is made of a foam material such as a closed-cell cross-linked foam.

The non-adhesive side of the pressure-sensitive adhesive tape having retroreflective beads melted therein may exhibit an initial reflective brightness prior to being subjected to abrasion cycles and a final reflective brightness after being subjected to a number of abrasion cycles. An abrasion cycle is generally defined in this application as one cycle through a Martindale Wear & Abrasion Tester model GJS 037, available from Goodbrand Jeffreys Sales LTD of Stockport, England, using standard abrasive fabric SDL-235B available from Lawson-Hemphill Sale, Inc. of Spartanburg, S.C. Brightness testing before and after abrading the material is an indication of how well the reflective beads are bonded to the backing.

In accordance with the techniques described herein, the final reflective brightness of the material may be greater than seventy percent of the initial reflective brightness when the number of abrasion cycles is approximately 750, or even greater than ninety percent of the initial reflective brightness when the number of abrasion cycles is approximately 750. In some cases, the final reflective brightness is greater than ninety percent of the initial reflective brightness when the number of abrasion cycles is greater than 5000.

In another aspect, this disclosure is directed toward an article comprising a foam backing having a first side and a second side, and a layer of retroreflective beads melted into the first side of the foam backing. The beads can be melted into the first side of the foam backing using a laminator. In this manner, the use of an adhesive material or resin to attach the beads to the foam backing can be eliminated. The second side of the foam backing may be coated with a pressure-sensitive adhesive material to allow the foam backing to be comfortably adhered to human skin, or alternatively, the second side of the foam backing may be uncoated. In the later case, the foam backing with embedded beads may be sold as a disposable retroreflective foam material.

In other aspects, this disclosure is directed toward one or more methods. For example, a method may include covering a non-adhesive side of a pressure-sensitive adhesive tape with retroreflective beads and applying heat and pressure to melt the retroreflective beads into the non-adhesive side of the pressure-sensitive adhesive tape. The retroreflective beads may comprise glass beads half coated with aluminum, in which case the beads may be either randomly oriented on the non-adhesive side of the pressure-sensitive adhesive tape, or purposely oriented such that the non-coated surface of each bead is substantially exposed to the atmosphere. Alternatively, the retroreflective beads may be fully aluminum coated glass beads, in which case the method further comprises etching aluminum from exposed surfaces of the retroreflective beads.

In another aspect, a method includes covering a first side of a foam backing with retroreflective beads and applying heat and pressure to melt the retroreflective beads into the first side of the foam backing. Again, the use of an adhesive or resin to affix the beads on the first side of the foam backing is avoided. For example, the heat and pressure may be applied using a laminator.

Removable retroreflective material, as described herein, can provide a number of advantages. Retroreflective pressure-sensitive adhesive tape is particularly useful in providing non-permanent retroreflective characteristics to one or more surfaces, such as skin or clothing. Consequently, individuals walking during nighttime or twilight hours can apply the retroreflective pressure-sensitive tape to their skin, for example, so that they are more conspicuous to night motorists.

In addition, because the retroreflective beads are affixed using heat and pressure, the use of a curable adhesive material or resin is avoided. This can substantially reduce production time and costs. Consequently, the retroreflective pressure-sensitive adhesive tape can be used as a disposable retroreflective material. After use, the low cost retroreflective tape can be easily removed and discarded. Moreover, because the tape is disposable, a higher degree of wear may be tolerable. In other words, a reduction of retroreflectivity of the tape over time may be more acceptable because the tape is eventually discarded after a limited number of uses.

To further reduce costs, the pressure-sensitive adhesive tape may also utilize lower cost backing than other conventional retroreflective material, such as retroreflective clothing patches that are more permanent in nature. For example, foam backing may be used as opposed to extruded non-woven material, although non-woven materials may also be used. However, non-woven materials are fabric-like materials, and may not be as well suited for use in many applications of pressure-sensitive adhesive tape. In addition, as shown in the examples below, foam backing can be used to produce disposable retroreflective material that has better reflective brightness characteristics than disposable retroreflective material using non-woven material. Still, the retroreflective material created using foam backing may be very wear resistant, as shown by the examples below.

Additional details of these and other embodiments are set forth in the accompanying drawings and the description below. Other features, objects and advantages will become apparent from the description and drawings, and from the claims.

### BRIEF DESCRIPTION OF THE DRAWINGS

FIG. 1 is an illustration of a human arm having retroreflective pressure-sensitive adhesive tape comfortably adhered to the person's skin.

FIG. 2 is a perspective side view of retroreflective pressure-sensitive adhesive tape. FIG. 2 is not necessarily to scale, and is intended to be merely illustrative and non-limiting.

FIGS. 3-5 are flow diagrams.

### DETAILED DESCRIPTION

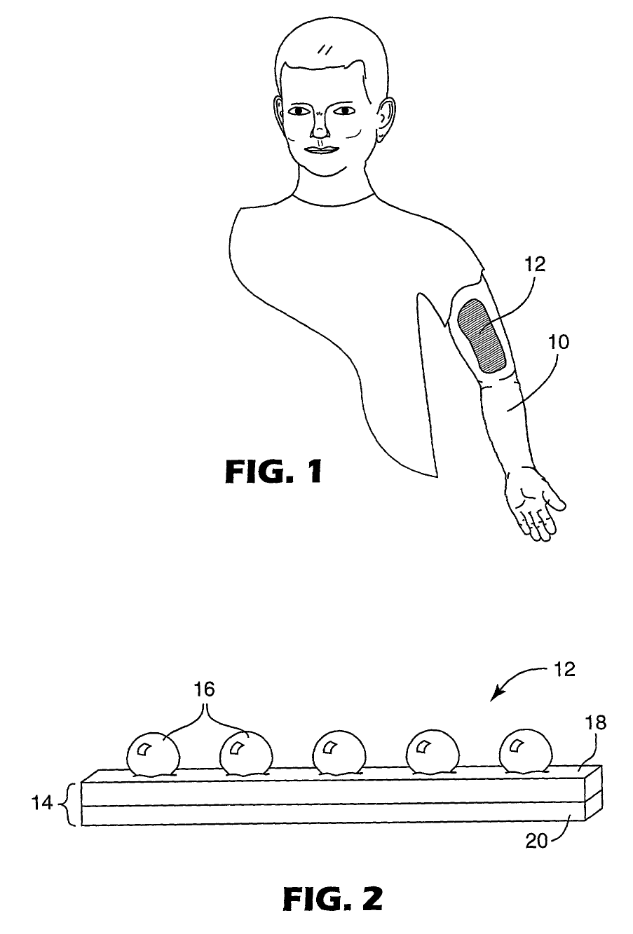

FIG. 1 is an illustration of a human arm 10 having retroreflective material 12 comfortably adhered thereto using a pressure-sensitive adhesive. In particular, retroreflective material 12 may comprise a disposable pressure-sensitive adhesive tape, such as medical tape. Retroreflectivity can be provided, for example, by melting retroreflective beads into the non-adhesive side of the tape.

Retroreflective material 12 is particularly useful in providing non-permanent retroreflective characteristics to one or more surfaces, such as skin or clothing. Consequently, individuals walking during nighttime or twilight hours can apply the retroreflective tape to their skin, for example, so that they are more conspicuous to night motorists. The relatively low cost of retroreflective material 12 compared with other retroreflective materials allows material 12 to be used as a disposable product. After use, the low cost retroreflective material 12 can be easily removed and discarded.

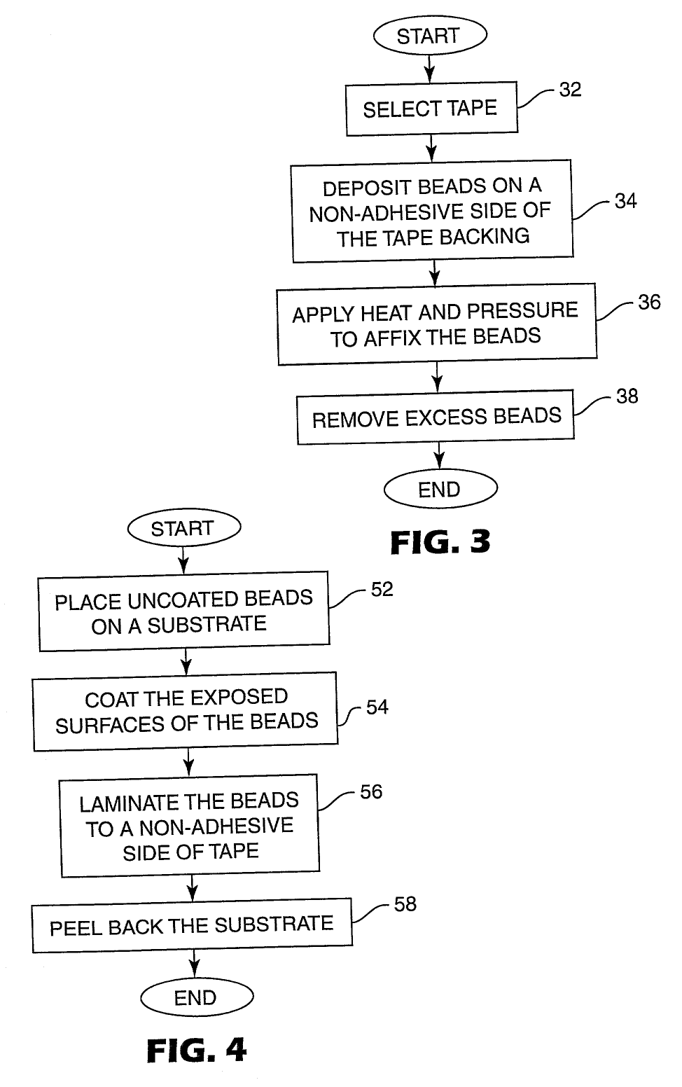

FIG. 2 is a perspective side view of retroreflective material 12. Retroreflective material 12 includes a pressure sensitive adhesive tape 14, such as medical tape, in which a pressure-sensitive adhesive 20 is coated or otherwise applied onto a first side of backing 18. Backing 18 may be a medical foam backing or a medical non-woven backing, although the use of a foam backing may be preferred for cost reasons, or other reasons. The use of medical backing can ensure that the material is safe for application to human skin. A layer of retroreflective beads 16 is melted into a second side of backing 18 to provide a retroreflective surface.

Backing 18 may be comprised of a thermoplastic material, including a thermoplastic foam or a thermoplastic non-woven material. Under some conditions, however, a foam backing may be better suited for many tape applications. For example, under some conditions, foam backing may be produced at lower costs than non-woven alternatives, making it particularly well suited for disposable applications. Moreover, foam backing may be better suited for some tape applications than non-woven alternatives or other fabric alternatives. In particular, as evidenced by examples below, foam backing can be used to produce retroreflective material that has higher reflective brightness characteristics than material created using non-woven alternatives. Still, the retroreflective material created using foam backing may be very wear resistant, as shown by the examples below.

The retroreflective beads 16 can be affixed to backing 18 without the use of an adhesive or resin. Instead, a lamination process or other suitable process may be used to melt the beads 16 into backing 18 using heat and pressure. Avoiding the use of an adhesive or resin can reduce production costs and reduce production time by avoiding the need to cure the adhesive or resin. Depending on the size of beads 16, backing 18 may be created to have sufficient thickness to ensure that the beads can be adequately melted into backing 18.

In other aspects, retroreflective beads 16 are melted into a first side of foam backing, which may or may not include the pressure-sensitive adhesive material on the second side. For example, the foam backing may comprise a closed-cell cross-linked foam. Again, the foam backing may be medical foam backing to ensure that it is safe for application to human skin. The beads can be melted into the first side of the foam backing using the lamination techniques described in greater detail below.

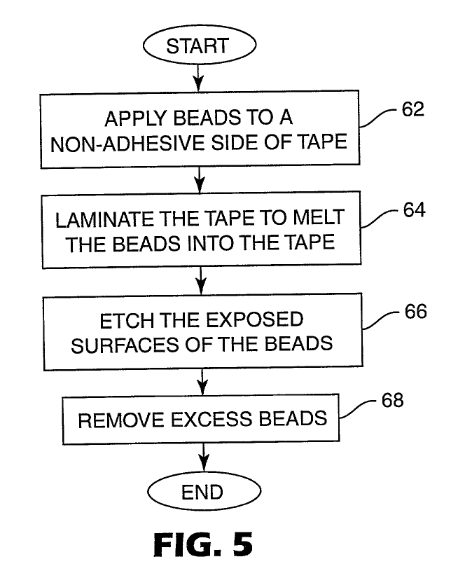

FIG. 3 is a flow diagram illustrating an example process for forming the disposable retroreflective material. In particular, a tape having a pressure-sensitive adhesive on one side of a backing is selected (32). The pressure-sensitive adhesive tape may include a non-woven backing or a foam backing, although foam backing may provide better results as discussed above. Retroreflective beads are then randomly deposited on a non-adhesive side of the backing (34). Application of heat and pressure affixes the beads in the non-adhesive side of the backing (36). In other words, the heat and pressure melts the beads into the non-adhesive side of the backing. Any loose or excess beads may then be removed, e.g., by shaking the material or wiping the beaded surface of the material clean (38). The material can then be immediately used, without waiting for a resin or adhesive to cure or dry. In one case, heat and pressure is applied using a laminator. A similar process to that illustrated in FIG. 3 could also be used to create disposable retroreflective material such as a retroreflective foam backing, which may or may not include a pressure-sensitive adhesive material on one side.

FIG. 4 is another flow diagram illustrating another process that can be used, in particular, to realize a retroreflective foam material. As shown, uncoated glass beads are placed on a substrate (52). For example, the beads may be set in a resin on the substrate such that approximately half of the surface area of the beads are exposed to the atmosphere. The exposed surfaces of the beads are then coated with aluminum or another suitable reflective agent (54). The beads in the substrate are then laminated to a non-adhesive side of a pressure-sensitive adhesive tape having a foam backing (56). Alternatively, the beads in the substrate may be laminated to a first side of a foam backing which may or may not include a pressure-sensitive adhesive on the second side.

At this point, the beads are oriented in the non-adhesive side of the pressure-sensitive adhesive tape such that the aluminum coated surfaces are melted into the tape. The substrate can then be peeled back (58), exposing the non-aluminum coated sides of the beads to the atmosphere. The substrate can be discarded.

FIG. 5 is yet another flow diagram illustrating another process that can be used to realize a retroreflective pressure-sensitive adhesive tape. As shown, aluminum coated beads (or beads coated with another suitable reflective agent) are applied to a non-adhesive side of a pressure-sensitive adhesive tape such as medical tape (62). Alternatively, the beads may be applied to a first side of a foam backing which may or may not include a pressure-sensitive adhesive on the second side. The pressure-sensitive adhesive tape can then be laminated to melt the beads into the non-adhesive side (64). The exposed surfaces of the aluminum coated beads can then be etched (66), so that only the surface of the beads which are melted into the non-adhesive side of the pressure-sensitive adhesive remain aluminum coated. Any loose or excess beads may then be removed, e.g., by shaking the material or wiping the beaded surface of the material clean (68).

Retroreflective pressure-sensitive adhesive tape, as described herein, can be used to provide non-permanent retroreflective characteristics to skin or fabric. The tape can be easily applied and then discarded after use. The tape can be originally stored on a release liner and rolled up into a roll. Strips of tape may then be cut from the roll according to desired size. In other cases, the tape may be precut into sections, which may be peeled from the release liner, for example, and the applied on various surfaces, as desired.

### EXAMPLES

In the following examples, different processes were used to create retroreflective material. Brightness testing was then performed. In the brightness testing, “Reflectivity” or “reflective brightness” of a retroreflective material is a measure of the apparent brightness of the material when viewed under standard retroreflective conditions, i.e., 0° orientation angle, −4° entrance angle, and 0.2° observation angle. The brightness is normalized for the area of the material and the illumination from the light source used. The reflectivity or reflective brightness is also referred to as the coefficient of retroreflection (R_{A}), and is expressed in units of candelas per lux per square meter (cd/(lux-m²)). Reference is made to ASTM Standard Method #808-94, “Standard Practice For Describing Retroreflection.” The instrument used for measurements was built according to ASTM specifications.

Abrasion testing was also performed in the various examples. The abrasion testing was done on a Martindale Wear & Abrasion Tester model GJS 037, available from Goodbrand Jeffreys Sales LTD of Stockport, England, using standard abrasive fabric SDL-235B available from Lawson-Hemphill Sale, Inc. of Spartanburg, S.C. Brightness testing before and after abrading the material is an indication of how well the reflective beads are bonded to the substrate.

### Example 1

A piece of 1774 W Polyethylene Medical Foam Tape, commercially available from Minnesota Mining and Manufacturing Company of St. Paul, Minn. (hereafter 3M), was placed on the platen of a laminator with the foam side up. The laminator was a HIX Model N-800, available from HIX Corp. of Pittsburg, Kans. Half-aluminized glass beads, sold by 3M as #145 Reflective Glass Elements, were poured over the foam surface. The sample was laminated at 325° F. (163° C.), 40 PSI (276 kPa), for 15 seconds. Loose beads were then shaken off.

The finished sample had an R_{A} of about 100. The reflective beads were not dislodged by brushing or shaking the tape. During a 5 kilometer walk during the summer with strips of the tape applied to her legs, a person reported that the tape was comfortable and easily removed. When applied to T-shirts, sweatshirts, and nylon jackets, the tape remained in place and had good brightness retention.

Four replicate samples were tested for brightness before and after abrasion testing. The results of the brightness testing are provided in TABLE A below.

TABLE A

| Initial R_{A} | R_{A} after 750 abrasion cycles |
|---|---|
| 97 | 76 |
| 96 | 81 |
| 96 | 78 |
| 99 | 76 |

### Example 2

A piece of silicone release liner, i.e., a substrate, was placed on the platen of the laminator. Fully aluminized glass beads were poured onto the release liner as described in PCT patent publication WO 01/42823 A1, published Jun. 14, 2001, which is assigned to the same assignee as this application, and which is hereby incorporated herein by reference in its entirety. 1774 W Polyethylene Medical Foam Tape, commercially available from 3M was placed foam side down onto the beads. The sample was laminated at 325° .F (163° C.), 40 PSI (276 kPa), for 15 seconds before removing the sample from the laminator. Loose beads were then shaken off. As taught in the above referenced patent publication, the aluminum on the exposed surface of the beads was removed by placing the sample into 0.5 M NaOH solution and mildly agitating the sample until the beaded surface changed from a dull gray to a whitish silver, which took about 2 minutes. The finished sample had an RA of about 300.

### Example 3

1774 W Polyethylene Medical Foam Tape, commercially available 3M was placed on the platen of the laminator with the foam side up. A piece of Scotchlite™ 5721 Silver Graphic Transfer Film, commercially available from 3M, was laid onto the foam with the beaded side against the foam. The sample was laminated at 300° F. (149° C.), 40 PSI (276 kPa), for 60 seconds. The substrate of the graphic transfer film was stripped off 24 hours later. The finished sample had an RA of approximately 500.

### Example 4

A piece of Volara™ 5 TS foam, 0.79 mm thick and a piece of Volara 12EO foam, 0.51 mm thick, both commercially available from Voltek Corp. of Lawrence, Mass., were attached to a paper liner, Polyethylene CIS “MAL grade” paper, available from Felix Schoeller Technical Papers, Inc., Pulaski, N.Y., using a double-coated adhesive tape, F9465C Transfer Film, available from 3M. These foams are closed-cell cross-linked polyolefin foams. Half-aluminized glass beads, sold by 3M as #145 Reflective Glass Elements were poured over the foam surfaces and the samples were laminated at 325° F. (163° C.), 40 PSI (276 kPa), for 15 seconds. Initial brightness and brightness after abrasion was tested. Testing on the 12EO foam was terminated after 1500 cycles. TABLE B summarizes the results of the brightness testing.

TABLE B

| Number of abrasion cycles | 12 EO foam (R_{A}) | 5 TS foam (R_{A}) |
|---|---|---|
| 0 cycles (Initial brightness) | 98 | 107 |
| 750 | 46 | 89 |
| 1500 | 19 | 87 |
| 2250 | | 79 |
| 3000 | | 81 |
| 3750 | | 76 |
| 4500 | | 73 |
| 5250 | | 73 |

### Example 5

Foam backings like those used in Example 4 were laminated to a graphic transfer film like that used in Example 3. Brightness before and after abrasion was tested. TABLE C summarizes the results of the brightness testing.

TABLE C

| Number of abrasion cycles | 12 EO foam (R_{A}) | 5 TS foam (R_{A}) |
|---|---|---|
| 0 cycles (Initial brightness) | 519 | 518 |
| 750 | 520 | 533 |
| 1500 | 514 | 533 |
| 2250 | 518 | 533 |
| 3000 | 501 | 532 |
| 3750 | 498 | 520 |
| 4500 | 503 | 533 |
| 5250 | 503 | 537 |

### Example 6

A piece of silicone release liner was placed on the platen of the laminator. The glass beads used in Example 1 were poured onto the release liner. A piece of a pressure-sensitive adhesive coated, fibrous, breathable non-woven tape backing like that described in commonly assigned U.S. Pat. No. 6,017,219 was placed fiber side down onto the beads. The sample was laminated at 350° F. (177° C.), 40 PSI (276 kPa) for 60 seconds. Loose beads were shaken off. The above mentioned U.S. Pat. No. 6,017,219 is hereby incorporated by reference herein in its entirety.

The finished sample had an R_{A} of about 90. The beads were firmly attached to the tape substrate, being difficult to remove by rubbing, flexing, or scratching with a fingernail. Samples of the tape that were applied to skin during a walk of approximately 5 kilometers. The samples were comfortable, stayed in place, and were easy to remove. Samples were also applied to clothing with similar results.

Brightness before and after abrasion was tested. TABLE D summarizes the results of the brightness testing of the sample made in Example 6.

TABLE D

| Number of abrasion cycles | R_{A} |
|---|---|
| 0 cycles (Initial brightness) | 91 |
| 750 | 70 |
| 1500 | 68 |
| 2250 | 66 |
| 3000 | 64 |
| 3750 | 63 |
| 4500 | 64 |
| 5250 | 62 |

### Example 7

A piece of silicone release liner was placed on the platen of the laminator. Fully aluminized glass beads like those used in Example 2 were poured onto the release liner. Tape like that used in Example 6 was placed fiber side down onto the beads. The sample was laminated at 325° F. (163° C.), 40 PSI (276 kPa) for 40 seconds. Loose beads were shaken off. The aluminum on the exposed surface of the beads was removed by placing the sample into 1.0 M NaOH solution and mildly agitating the sample until the beaded surface changed from a dull gray to a whitish silver, which took about 2 minutes. The finished sample had an R_{A} of about 300.

Brightness before and after abrasion was tested. TABLE E summarizes the results of the brightness testing of the sample made in Example 7.

TABLE E

| Number of abrasion cycles | R_{A} |
|---|---|
| 0 cycles (Initial brightness) | 293 |
| 750 | 244 |
| 1500 | 236 |
| 2250 | 233 |
| 3000 | 224 |
| 3750 | 223 |
| 4500 | 218 |
| 5250 | 214 |

A number of implementations and embodiments have been described. For instance, disposable retroreflective pressure-sensitive adhesive tape has been described that can be safely and comfortable adhered to human skin. In addition, retroreflective foam backing for use in adhesive tape or other applications has been described. Nevertheless, it is understood that various modifications can be made without departing from the spirit and scope of this disclosure. Accordingly, other implementations and embodiments are within the scope of the following claims.

1. An article comprising:
a tape including an adhesive side and a non-adhesive side, wherein the adhesive side is coated with a pressure-sensitive adhesive; and
a layer of retroreflective beads melted into the non-adhesive side of the tape.

2. The article of claim 1, wherein the tape is medical tape capable of being comfortably adhered to human skin.

3. The article of claim 1, wherein the layer of retroreflective beads is laminated into the non-adhesive side of the tape.

4. The article of claim 1, wherein the tape is medical tape having a foam backing.

5. The article of claim 1, wherein the tape is medical tape having a non-woven backing.

6. The article of claim 1, wherein the layer of retroreflective beads exhibits an initial reflective brightness prior to being subjected to abrasion cycles and a final reflective brightness after being subjected to a number of abrasion cycles, wherein the final reflective brightness is greater than seventy percent of the initial reflective brightness when the number of abrasion cycles is approximately 750.

7. The article claim 1, wherein the layer of retroreflective beads exhibits an initial reflective brightness prior to being subjected to abrasion cycles and a final reflective brightness after being subjected to a number of abrasion cycles, wherein the final reflective brightness is greater than ninety percent of the initial reflective brightness when the number of abrasion cycles is approximately 750.

8. The article claim 1, wherein the layer of retroreflective beads exhibits an initial reflective brightness prior to being subjected to abrasion cycles and a final reflective brightness after being subjected to a number of abrasion cycles, wherein the final reflective brightness is greater than ninety percent of the initial reflective brightness when the number of abrasion cycles is greater than 5000.

9. The article of claim 1, wherein the layer of retroreflective beads is substantially held in place on the non-adhesive side of the tape without the use of an additional adhesive or a resin.

10. An article comprising:
foam backing including a first side and a second side; and
a layer of retroreflective beads melted into the first side of the foam backing.

11. The article of claim 10, wherein the layer of retroreflective beads melted into the first side exhibits an initial reflective brightness prior to being subjected to abrasion cycles and a final reflective brightness after being subjected to a number of abrasion cycles, wherein the final reflective brightness is greater than seventy percent of the initial reflective brightness when the number of abrasion cycles is approximately 750.

12. The article of claim 10, wherein the layer of retroreflective beads melted into the first side exhibits an initial reflective brightness prior to being subjected to abrasion cycles and a final reflective brightness after being subjected to a number of abrasion cycles, wherein the final reflective brightness is greater than ninety percent of the initial reflective brightness when the number of abrasion cycles is approximately 750.

13. The article of claim 10, wherein the layer of retroreflective beads melted into the first side exhibits an initial reflective brightness prior to being subjected to abrasion cycles and a final reflective brightness after being subjected to a number of abrasion cycles, wherein the final reflective brightness is greater than ninety percent of the initial reflective brightness when the number of abrasion cycles is greater than 5000.

14. The article of claim 10, wherein the layer of retroreflective beads is substantially held in place on the first side of the foam backing without the use of an additional adhesive or a resin.

15. A method comprising:
covering a non-adhesive side of a pressure-sensitive adhesive tape with retroreflective beads; and
applying heat and pressure to melt the retroreflective beads into the non-adhesive side of the pressure-sensitive adhesive tape.

16. The method of claim 15, wherein the retroreflective beads comprise glass beads coated with aluminum, wherein each glass bead is coated with aluminum on approximately half of a glass bead surface area.

17. The method of claim 15, wherein the retroreflective beads are fully aluminum coated glass beads, the method further comprising etching aluminum from exposed surfaces of the retroreflective beads.

18. The method of claim 15, wherein applying heat and pressure comprises laminating the retroreflective beads onto the non-adhesive side of the pressure-sensitive adhesive tape.

19. A method comprising:
covering a first side of a foam backing with retroreflective beads; and
applying heat and pressure to melt the retroreflective beads into the first side of the foam backing.

20. The method of claim 19, wherein the retroreflective beads comprise glass beads coated with aluminum, wherein each glass bead is coated with aluminum on approximately half of a glass bead surface area.

21. The method of claim 19, wherein the retroreflective beads are fully aluminum coated glass beads, the method further comprising etching aluminum from exposed surfaces of the retroreflective beads.

22. The method of claim 19, wherein applying heat and pressure comprises laminating the retroreflective beads into the first side of the foam backing.

23. An article comprising:
a foam backing including first and second sides;
a pressure-sensitive adhesive material covering the first side; and
a layer of retroreflective beads melted into the second side.

24. The article of claim 23, wherein the article is made by the process of:
coating the first side of the foam backing with the pressure-sensitive adhesive material;
covering the second side of the foam backing with retroreflective beads; and
applying heat and pressure to affix the retroreflective beads on the second side of the foam backing.

25. The article of claim 24, wherein applying heat and pressure comprises laminating the retroreflective beads onto the second side of the foam backing.

26. The article of claim 23, wherein the layer of retroreflective beads exhibits an initial reflective brightness prior to being subjected to abrasion cycles and a final reflective brightness after being subjected to a number of abrasion cycles, wherein the final reflective brightness is greater than seventy percent of the initial reflective brightness when the number of abrasion cycles is approximately 750.

27. The article of claim 23, wherein the layer of retroreflective beads exhibits an initial reflective brightness prior to being subjected to abrasion cycles and a final reflective brightness after being subjected to a number of abrasion cycles, wherein the final reflective brightness is greater than ninety percent of the initial reflective brightness when the number of abrasion cycles is approximately 750.

28. The article of claim 23, wherein the layer of retroreflective beads exhibits an initial reflective brightness prior to being subjected to abrasion cycles and a final reflective brightness after being subjected to a number of abrasion cycles, wherein the final reflective brightness is greater than ninety percent of the initial reflective brightness when the number of abrasion cycles is greater than 5000.

29. The article of claim 23, wherein the layer of a layer of retroreflective beads is substantially held in place on the first side of the foam backing without the use of an adhesive or a resin.

30. The article of claim 23, wherein the foam backing comprises a closed-cell cross-linked foam.

31. An article comprising:
a medical tape capable of being comfortably adhered to human skin, the medical tape including an adhesive side and a non-adhesive side, wherein the adhesive side is coated with a pressure-sensitive adhesive; and
a layer of retroreflective beads laminated into the non-adhesive side of the medical tape without the use of an adhesive or resin, wherein the layer of retroreflective beads exhibits an initial reflective brightness prior to being subjected to abrasion cycles and a final reflective brightness after being subjected to a number of abrasion cycles, wherein the final reflective brightness is greater than seventy percent of the initial reflective brightness when the number of abrasion cycles is approximately 750.

32. The article of claim 31, wherein the medical tape includes a foam backing.

33. The article claim 31, wherein the final reflective brightness is greater than ninety percent of the initial reflective brightness when the number of abrasion cycles is greater than 5000.
